(19) United States
(12) Patent Application Publication
(10) Pub. No.: US 2023/0336963 A1
(43) Pub. Date: Oct. 19, 2023

(54) NETWORKING METHOD OF WIRELESS DEVICE, GATEWAY DEVICE AND STORAGE MEDIUM

(71) Applicant: SENGLED CO., LTD., Shanghai (CN)

(72) Inventors: Xia WANG, Shanghai (CN); Xuanming CAO, Shanghai (CN); Weibo QIAN, Shanghai (CN)

(21) Appl. No.: 18/043,139

(22) PCT Filed: Aug. 24, 2021
(86) PCT No.: PCT/CN2021/114332

§ 371 Date: Feb. 27, 2023

(30) Foreign Application Priority Data
Aug. 27, 2020 (CN) 202010875390.2

(51) Int. Cl. H04W 8/00; H04W 24/02; H04L 41/08

(52) U.S. Cl. CPC H04W 8/005; H04W 24/02; H04L 41/0886; H04W 88/16

(57) ABSTRACT

A networking method for a wireless device applied to a gateway device, includes receiving a wireless device adding instruction through a client, adding a scanned, to-be-added, wireless device to a network constructed by the gateway device according to the wireless device adding instruction, acquiring type information of the wireless device and determining corresponding preset configuration information according to the type information of the wireless device, and configuring a corresponding wireless device according to preset configuration information.

### CROSS-REFERENCES TO RELATED APPLICATIONS

This application is a national stage entry of application PCT/CN2021/114332 filed on Aug. 24, 2021, which claims priority to Chinese Patent Application No. 202010875390.2, filed Aug. 27, 2020, the entire content of both of which are incorporated herein by reference.

### TECHNICAL FIELD

The present disclosure relates to the field of network technology and, in particular, to a networking method for wireless device, a gateway device, and a storage medium.

### BACKGROUND

With the popularity of the Internet of Things (“IoT”) and smart homes, a network is constructed by more and more wireless devices using gateway devices.

In the existing networking method of the wireless devices, a user scans a QR code on a wireless device through a mobile phone application (App) to obtain wireless device information, and then transmits the wireless device information to the gateway device, thereby adding the wireless device to the network constructed by the gateway device.

However, when a plurality of wireless devices need to join the network, the user needs to scan each wireless device separately, which is cumbersome and time-consuming, and the user experience is poor.

### SUMMARY

Embodiments of the present disclosure provide a networking method for a wireless device applied to a gateway device, includes receiving a wireless device adding instruction sent by a user through a client, adding a scanned, to-be-added, wireless device to a network constructed by the gateway device according to the wireless device adding instruction, acquiring type information of the wireless device and determining corresponding preset configuration information according to the type information of the wireless device, and configuring a corresponding wireless device according to preset configuration information.

Embodiments of the present disclosure further provide a gateway device including a reception module used to receive a wireless device adding instruction sent by a user through a client, an addition module used to add a scanned , to-be-added, wireless device to a network constructed by the gateway device according to the wireless device adding instruction, a determination module used to acquire type information of the wireless device and determine corresponding preset configuration information according to the type information of the wireless device, and a configuration module used to configure a corresponding wireless device according to preset configuration information.

Embodiments of the present disclosure further provide a gateway device including a memory storing a computer program and a processor. The processor is configured to executes the computer program to receive a wireless device adding instruction sent by a user through a client, add a scanned , to-be-added, wireless device to a network constructed by the gateway device according to the wireless device adding instruction, acquire type information of the wireless device and determine corresponding preset configuration information according to the type information of the wireless device, and configure a corresponding wireless device according to preset configuration information.

Embodiments of the present disclosure further provide a computer-readable storage medium storing a computer program. When a processor executes the computer program, a method is realized including receiving a wireless device adding instruction sent by a user through a client, adding a scanned, to-be-added, wireless device to a network constructed by the gateway device according to the wireless device adding instruction, acquiring type information of the wireless device and determining corresponding preset configuration information according to the type information of the wireless device, and configuring a corresponding wireless device according to preset configuration information.

### BRIEF DESCRIPTION OF THE DRAWINGS

FIG. 1 is a schematic diagram of a network architecture consistent with embodiments of the present disclosure.

FIG. 2 is a schematic flow chart of a networking method of a wireless device consistent with the present disclosure.

FIG. 3 is a schematic flow chart of another networking method of a wireless device consistent with the present disclosure.

FIG. 4 is a schematic specific flow chart of a networking method of a wireless device consistent with the present disclosure.

FIG. 5 is a schematic structural diagram of an example getaway device consistent with the present disclosure.

FIG. 6 is a schematic diagram of hardware structure of an example gateway device consistent with the present disclosure.

### DETAILED DESCRIPTION OF THE EMBODIMENTS

To make the objectives, technical solutions, and advantages of the embodiments of the present disclosure clearer, the technical of the present disclosure will be described with reference to the drawings.

The process to construct a network with one or more wireless devices is complicated and time-consuming, often causing a poor user experience. With the increasing number of product types of the wireless devices, such construction process is becoming more and more complicated. Therefore, wireless gateway devices are often used to manage the wireless device of a home intelligent network.

In the existing networking method of the wireless device, a user scans a QR code on the wireless device through a mobile phone application (App) to obtain wireless device information, and then transmits the wireless device information to the gateway device, thereby adding the wireless device to the network constructed by the gateway device.

However, when a plurality of wireless devices need to join the network, the user needs to scan each wireless device separately, which is cumbersome and time-consuming. In addition, the QR code on the wireless device may be damaged or lost, which may cause the user to be unable to scan accurately. Moreover, when the wireless device has been mounted at a certain location, the user also needs to remove the wireless device for scanning. Thus, the user experience is poor.

To solve such problems, in embodiments of the present disclosure, after the gateway device receives a wireless device adding instruction by the user, the gateway device can automatically scan the wireless devices in the surrounding environment, and automatically add and configure the wireless devices to the network.

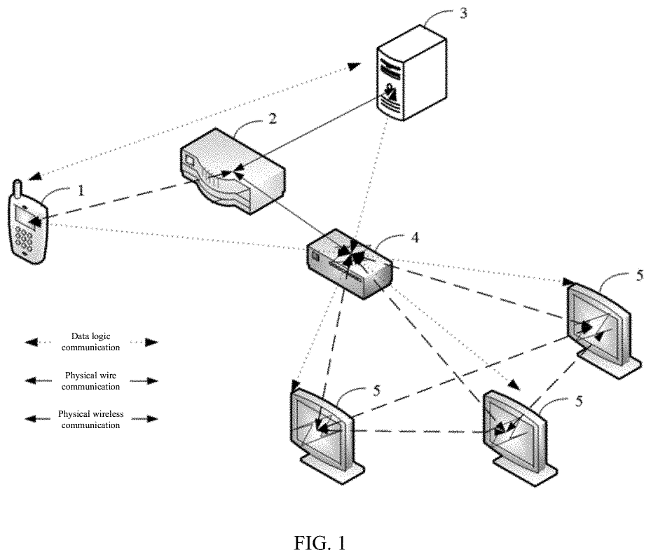

FIG. 1 is a schematic diagram of an example network architecture on which the present disclosure is based. As shown in FIG. 1, one of the network architectures on which the present disclosure is based may include a user terminal 1, a router 2, a cloud server 3, a gateway device 4, and a plurality of wireless devices 5. The user terminal 1, router 2, cloud server 3, gateway device 4, and wireless device 5 can connect with each other via data logic communication, physical wire communication, or physical wireless communication shown in FIG. 1. The gateway device 4 may be used to implement the networking methods described in the following embodiments to realize the networking of the plurality of wireless devices 5.

The gateway device 4 includes a wireless module, which is used to manage each wireless device 5 to construct a network, and to connect to the gateway device (i.e., router 2 in FIG. 1) of a wide area network (WAN). The user terminal 1 can be a smart terminal, such as a mobile phone, a tablet, or a computer, etc. The corresponding App is installed on the client, which can be used to receive user operation instructions to implement various operations on the gateway device 4. The router 2 is a network communication relay with a wireless hotspot, which is used for network communication. The user terminal 1 can be associated with the router 2 through the physical wireless communication. The cloud server 3 can be a server cluster, which is used to store information of each the user terminal 1 and transfer control information and status information of the user terminal 1. The cloud server 3 is a key device for realizing remote control and reporting status of the wireless device. The wireless device 5 can be a wireless terminal device, such as a smart lamp, a smart door sensor, or a smart socket, etc.

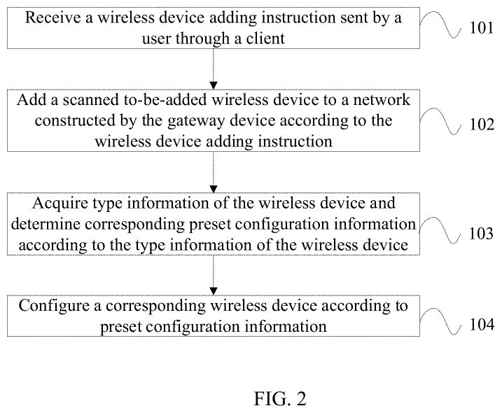

FIG. 2 is a schematic flow chart of a networking method of a wireless device consistent with the disclosure. As shown in FIG. 2, in one embodiment, the networking method of the wireless device includes following processes.

At 101, a wireless device adding instruction sent by a user through a client is received.

Specifically, process 101 is executed by the gateway device. The user sends the wireless device adding instruction to the gateway device by a manner, such as triggering the “add wireless device” function button of the corresponding App on the user terminal (e.g., mobile phone, tablet, computer, etc.). Correspondingly, the gateway device receives the wireless device adding instruction sent by the client.

At 102, a scanned, to-be-added, wireless device is added to the network constructed by the gateway device according to the wireless device adding instruction.

Specifically, after the gateway device receives the wireless device adding instruction, the gateway device may turn on the automatic scanning function to scan for a unnetworked wireless device in current network, and then add the scanned wireless device to the current network. In some embodiments, after the gateway device receives the wireless device adding instruction, the gateway device may start to construct a new network, and then add the unnetworked wireless device to the new network constructed. Constructing the network refers to constructing a same channel and connecting all wireless devices to the channel.

At 103, type information of the wireless device is acquired, and corresponding preset configuration information is determined according to the type information of the wireless device.

Specifically, the gateway device may send an instruction to acquire the type information of the wireless device to the wireless device. After the wireless device receives the instruction, the wireless device returns a corresponding type information of the wireless device to the gateway device, or the wireless device automatically reports the type information of the wireless device to the gateway device. In some embodiments, the type information of the wireless device includes one or more information, such as a media access control address (MAC), a product type, manufacturer information, a software version, a hardware version, or custom information, etc. After the gateway device receives the type information of the wireless device, the gateway device determines the corresponding preset configuration information according to the type information of the wireless device. The preset configuration information can be stored on the gateway device, and the gateway device determines the corresponding preset configuration according to the type information. Or the preset configuration information is stored on the cloud server, and the cloud server sends the corresponding preset configuration information to the gateway device.

At 104, a corresponding wireless device is configured according to preset configuration information.

Specifically, after the gateway device acquires the configuration information of each the wireless device, the gateway device configures the corresponding wireless device according to the configuration information of each the wireless device, thereby completing the networking of the wireless device.

In some embodiments, the gateway device supports multiple gateway protocols, and the wireless device has multiple functional modules. One way to implement process 104 is to bind each functional module of the wireless device with a corresponding gateway protocol.

Specifically, the gateway device can support multiple different protocols, such as protocols A, B, and C. The different protocols correspond to different functions of the wireless device. The different functions of the wireless device can include functions, such as dimming, color adjustment, switching, and alarming, etc. For example, the protocol A of the gateway device is bound with a dimming lamp of the wireless device, the protocol B can is bound with a color lamp of the wireless device, and the protocol C is bound with a switch of the wireless device.

In some embodiments, the networking method further includes that the gateway device is configured with a reporting mechanism of the wireless device. The reporting mechanism is used to instruct the wireless device to report action information when a preset action is triggered.

Specifically, while performing process 104 or after process 104, an irrelevant device can also be configured with the reporting mechanism of the wireless device to report the information, e.g., the status information, of the wireless device to the gateway device when the wireless device triggers a certain action or reaches a preset time.

In some embodiments, before process 104, the networking method further includes acquiring a first verification information of the wireless device, acquiring a second verification information sent by the cloud server, and configuring the corresponding wireless device according to the preset configuration information when the first verification information and the second verification information satisfies a preset condition.

Specifically, before configuring the wireless device, whether the identity of the wireless device is legal needs to be verified. One achievable verification method is to acquire the first verification information of the wireless device and acquire the second verification information sent by the cloud server, and to calculate the first verification information and the second verification information to determine whether the calculation result satisfies the preset condition. When the preset condition is satisfied, the verification is passed. In some embodiments, the advanced encryption standard (AES) algorithm of 128-bit packet encryption data is used for verification calculation.

The networking method of the wireless device consistent with the disclosure includes receiving the wireless device adding instruction sent by the user through the client, adding the scanned, to-be-added, wireless device to the network constructed by the gateway device according to the wireless device adding instruction, acquiring the type information of the wireless device and determining the corresponding preset configuration information according to the type information of the wireless device, and configuring the corresponding wireless device according to the preset configuration information. That is, the gateway device consistent with the embodiments of the present disclosure can automatically scan for the unnetworked wireless device in the surrounding environment to add the unnetworked wireless device to the network constructed by the gateway device after receiving the user instruction, thereby avoiding a need for the user to add the wireless devices one by one. Thus, the operation is simple, and the user experience is improved.

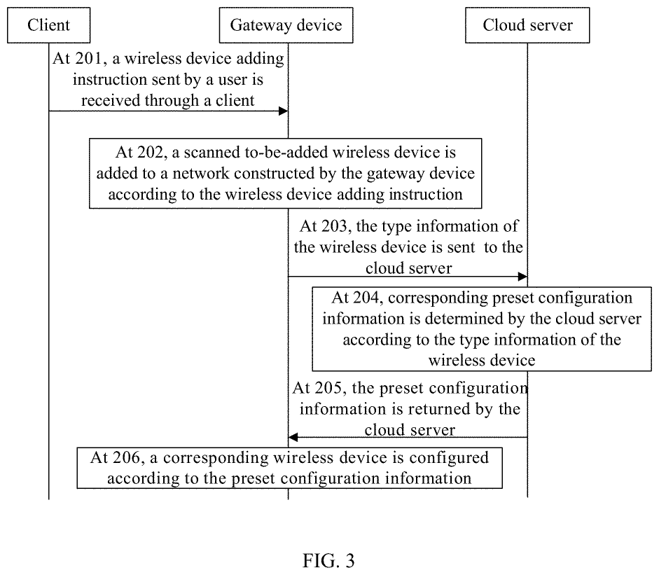

FIG. 3 is a schematic flow chart of another networking method of a wireless device consistent with the disclosure. As shown in FIG. 3, in one embodiment, the preset configuration information is stored in a cloud server. The networking method of the wireless device includes following processes.

At 201, a wireless device addition instruction sent by the user through the client is received.

At 202, a scanned, to-be-added, wireless device is added to a network constructed by a gateway device according to the wireless device adding instruction.

At 203, type information of the wireless device is sent to a cloud server.

At 204, corresponding preset configuration information is determined by the cloud server according to the type information of the wireless device.

At 205, the preset configuration information is returned by the cloud server.

Correspondingly, the gateway device receives the preset configuration information.

At 206, a corresponding wireless device is configured according to the preset configuration information.

The implementation of the processes 201, 202, and 206 consistent with the embodiments are similar to the above-described embodiments of the processes 101, 102, and 104, respectively, which are omitted here.

To reduce the consumption of storage resources in the gateway device, or to reduce the workload of the gateway device, in one embodiment, the preset configuration information is stored in the cloud server, the type information of the wireless device is sent to the cloud server, and the cloud server determines the corresponding preset configuration information according to the type information of the wireless device and returns the preset configuration information, and then the getaway device receives the preset configuration information.

Specifically, the device manufacturer of each wireless device can store the preset configuration information corresponding to different device types on the cloud server in advance. After the gateway device acquires the type information of the wireless device, the type information can be sent to the cloud server. The cloud server searches for the corresponding preset configuration information according to the type information, and returns the configuration information to the gateway device, to cause the gateway device finally is configured with the corresponding wireless device according to the configuration information.

In some embodiments, after process 206, the networking method further includes sending the type information of the wireless device and status information of the wireless device to the cloud server, to enable the cloud server to store the type information of the wireless device and the status of the wireless device in association with a preset user account of the user.

In some embodiments, the networking method further includes sending the type information of the wireless device and the status information of the wireless device to the client and forwarding the type information of the wireless device and the state information of the wireless device to the cloud server through the client, to enable the cloud server to store the type information of the wireless device and the status of the wireless device in association with the preset user account of the user.

Specifically, after the networking is completed, the information of successfully networking of the wireless device is usually synchronized to the cloud server. Generally speaking, the user opens a user account on the cloud server. After the successfully networking, the type information of the wireless device and the status information (whether the networking is successful) of the wireless device can be obtained through the gateway device. The gateway device can directly send the type information of the wireless device and the status information of the wireless device to the cloud server, or send to the cloud server through the client of the mobile phone of the user to be stored in association with the user account.

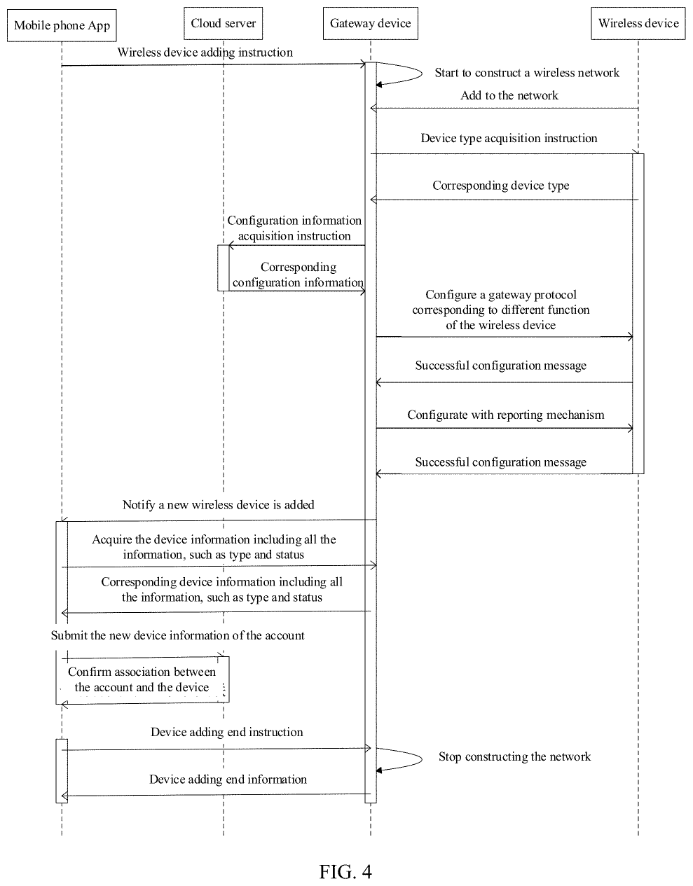

FIG. 4 is a schematic specific flow chart of a networking method of a wireless device consistent with the disclosure. As shown in FIG. 4, in one embodiment, the application scenario includes a mobile phone App, a cloud server, a gateway device, and a wireless device.

First, the user sends the wireless device adding instruction to the gateway device through the mobile phone App. The gateway device starts to construct a wireless network according to the wireless device adding instruction and adds a scanned wireless device to the network. Then the gateway device sends a device type information acquisition instruction to the wireless device, to obtain a device type. The wireless device reports a corresponding device type. The gateway device sends a configuration information acquisition instruction to the cloud server to acquire preset configuration information corresponding to the wireless device. The cloud server returns corresponding configuration information. Then the gateway device is configured with a gateway protocol corresponding to a different function of the wireless device according to the configuration information. After a successful configuration, the wireless device returns a message of the successful configuration. The wireless device can also be configured with a reporting mechanism of the wireless device. After the successful configuration, the wireless device returns the message of the successful configuration. Then the gateway device notifies the mobile phone App that a new wireless device is added. The user sends an instruction to acquire the device information through the mobile App to the gateway device, where the device information includes all information, such as type information and status information. The gateway device reports corresponding device information including all the information, such as the type information and the status information. Then the user submits the device information to the cloud server through the mobile phone App and stores the device information in association with the user account. After the storage is completed, the cloud server returns confirmation information to the mobile phone App and can then receive a device adding end instruction sent by the user through the mobile phone App. The gateway device stops constructing the network and returns device adding end information to the mobile phone App.

On the basis of the above-described embodiments, the method including storing the preset configuration information in the cloud server, sending the type information of the wireless device to the cloud server, determining the corresponding preset configuration information by the cloud server according to the type information of the wireless device, returning the preset configuration information by the cloud server, and receiving the preset configuration information, reduces the workload of the gateway device.

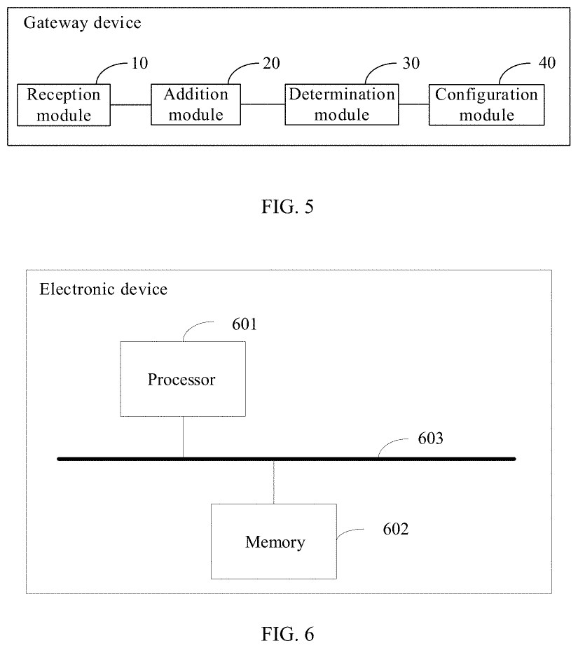

FIG. 5 is a schematic structural diagram of an example getaway device consistent with the disclosure. As shown in FIG. 5, the gateway device includes a reception module 10 used to receive a wireless device adding instruction sent by a user through a client, an addition module 20 used to add a scanned , to-be-added, wireless device to a network constructed by the gateway device according to the wireless device adding instruction, a determination module 30 used to acquire type information of the wireless device and determine corresponding preset configuration information according to the type information of the wireless device, and a configuration module 40 used to configure a corresponding wireless device according to the preset configuration information.

In some embodiments, the configuration module 40 is further used to configure a reporting mechanism of the wireless device. The reporting mechanism is used to instruct the wireless device to report action information when a preset action is triggered.

In some embodiments, the preset configuration information is stored in a cloud server. The determination module 30 is specifically used to send the type information of the wireless device to the cloud server, and the cloud server is used to determine the corresponding preset configuration information according to the type information of the wireless device and to return the preset configuration information. The determination module 30 is also used to receives the preset configuration information.

In some embodiments, the configuration module 40 is further used to acquire first verification information of the wireless device, acquire second verification information sent by the cloud server, and configure the corresponding wireless device according to the preset configuration information when the first verification information and the second verification information satisfies a preset condition.

In some embodiments, the configuration module 40 is further used to send the type information of the wireless device and status information of the wireless device to the cloud server, to enable the cloud server to store the type information of the wireless device and the status information of the wireless device in association with a preset user account of the user.

In some embodiments, the configuration module 40 is further used to send the type information of the wireless device and the status information of the wireless device to the client, and forward the type of the wireless device and the status information of the wireless device to the cloud server through the client, to enable the cloud server to store the type information of the wireless device and the state information of the wireless device in association with the preset user account of the user.

In some embodiments, the gateway device supports multiple gateway protocols, and the wireless device has multiple functional modules. The configuration module 40 is specifically used to bind each the functional module of the wireless device with a corresponding gateway protocol.

Those skilled in the art can clearly understand that, for convenience and concise description, the specific working process and corresponding beneficial effects of the gateway device described above can refer to the corresponding process in the above-described embodiments, which are omitted here.

The gateway device consistent with the embodiments of the present disclosure includes the reception module used to receive the wireless device adding instruction sent by the user through the client, the addition module used to add the scanned, to-be-added, wireless device to the network constructed by the gateway device according to the wireless device adding instruction, the determination module used to acquire the type information of the wireless device and determine the corresponding preset configuration information according to the type information of the wireless device, and the configuration module used to configure the corresponding wireless device according to the preset configuration information. That is, after receiving a user instruction, the gateway device can automatically scan for a unnetworked wireless device in the surrounding environment and add the unnetworked wireless device to the network constructed by the gateway device, thereby avoiding a need for the user to add the wireless devices one by one. Thus, the operation is simple, and the user experience is improved.

FIG. 6 is a schematic diagram of hardware structure of an example gateway device consistent with the disclosure. As shown in FIG. 6, the gateway device includes at least one processor 601 and memory 602.

In a specific implementation process, the at least one processor 601 executes a computer program stored in the memory 602, to enable the at least one processor 601 executes the above-described networking method of wireless device. The processor 601 and the memory 602 are connected through the bus 603.

The specific implementation process of the processor 601 may refer to the above-described embodiments, and the implementation principles and technical effects are similar, which are omitted here.

The at least one processor 601 may be a central processing unit (CPU), or may be another general-purpose processor, a digital signal processor (DSP), or an application specific integrated circuit (ASIC), etc. The general-purpose processor may be a microprocessor or any conventional processor. The processes of the method consistent with the present disclosure may be directly executed and completed by a hardware processor or may be executed and completed by a combination of hardware and a software module of the processor.

The memory may include a high-speed random-access memory (RAM), a non-volatile memory (NVM), for example, at least one disk memory.

The bus may be an Industry Standard Architecture (ISA) bus, a Peripheral Component Interconnect (PCI) bus, or an Extended Industry Standard Architecture (EISA) bus. The bus can be divided into address bus, data bus, control bus, and etc. For ease of representation, the bus in the drawings of the present disclosure is not limited to only one bus or only one type of bus.

The present disclosure also provides a computer-readable storage medium storing a computer program. When the processor executes the computer program, the above-described networking method of wireless device is implemented.

The computer-readable storage medium can be implemented by any type of volatile or non-volatile storage device or a combination thereof, such as a static random-access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disk. The computer-readable storage medium may be any available medium that can be accessed by a general-purpose computer or a special-purpose computer.

In one embodiment, the computer-readable storage medium is coupled to the processor to enable the processor to read information from the readable storage medium and write the information to the readable storage medium. The computer-readable storage medium may also be an integral part of the processor. The processor and the computer-readable storage medium may be located in the application specific integrated circuit (ASIC). The processor and the computer-readable storage medium may also exist in the device as discrete components.

Those skilled in the art can understand that all or some of the processes of the above-described method consistent with the embodiments of the present disclosure can be implemented by instructing relevant hardware according to a program. The program can be stored in a computer-readable storage medium. The program is executed to implement the processes included in the above-described embodiments. The storage medium can be any medium that can store program codes, for example, a ROM, a RAM, a magnetic disk, or an optical disk.

Other embodiments of the disclosure will be apparent to those skilled in the art from consideration of the specification and practice of the embodiments disclosed herein. It is intended that the specification and examples be considered as example only and not to limit the scope of the disclosure, with a true scope and spirit of the invention being indicated by the following claims.

What is claimed is:

1. A networking method for a wireless device applied to a gateway device, comprising:
receiving a wireless device adding instruction through a client;
adding a scanned, to-be-added, wireless device to a network constructed by the gateway device according to the wireless device adding instruction;
acquiring type information of the wireless device and determining corresponding preset configuration information according to the type information of the wireless device; and
configuring a corresponding wireless device according to preset configuration information.

2. The method of claim 1, further comprising:
configuring a reporting mechanism of the wireless device configured to instruct the wireless device to report action information in response to a preset action being triggered.

3. The method of claim 1, wherein:
the preset configuration information is stored in a cloud server; and
determining corresponding preset configuration information according to the wireless device information includes:
sending the type information of the wireless device to the cloud server;
determining the corresponding preset configuration information by the cloud server according to the type information of the wireless device; and
receiving the preset configuration information from the cloud server.

4. The method of claim 3, further comprising:
acquiring first verification information of the wireless device;
acquiring second verification information sent by the cloud server; and
configuring the corresponding wireless device according to the preset configuration information in response to the first verification information and the second verification information satisfying a preset condition.

5. The method of claim 1, further comprising, after configuring the corresponding wireless device according to the preset configuration information:
sending the type information of the wireless device and status information of the wireless device to the cloud server, the cloud server storing the type information of the wireless device and the status information of the wireless device associated with a preset user account.

6. The method of claim 1, further comprising, after configuring the corresponding wireless device according to the preset configuration information:
sending the type information of the wireless device and the status information of the wireless device to the client and forwarding the type information of the wireless device and the status information of the wireless device to the cloud server through the client, the cloud server storing the type information of the wireless device and the status information of the wireless device in association with the preset user account.

7. The method of claim 1, wherein:
the gateway device supports multiple gateway protocols, and the wireless device has multiple functional modules; and
configuring the corresponding wireless device according to the preset configuration information includes:
binding each the functional module of the wireless device with a corresponding gateway protocol.

8. A gateway device comprising:
a reception module configured to receive a wireless device adding instruction through a client;
an addition module configured to add a scanned, to-be-added, wireless device to a network constructed by the gateway device according to the wireless device adding instruction;
a determination module configured to acquire type information of the wireless device and determine corresponding preset configuration information according to the type information of the wireless device; and
a configuration module configured to configure a corresponding wireless device according to preset configuration information.

9. A gateway device comprising:
a memory storing a computer program; and
a processor configured to executes the computer program to:
receive a wireless device adding instruction through a client;
add a scanned, to-be-added, wireless device to a network constructed by the gateway device according to the wireless device adding instruction;
acquire type information of the wireless device and determine corresponding preset configuration information according to the type information of the wireless device; and
configure a corresponding wireless device according to preset configuration information.

10. The gateway device of claim 9, the processor is further configured to:
configure a reporting mechanism of the wireless device configured to instruct the wireless device to report action information in response to a preset action being triggered.

11. The gateway device of claim 9, wherein:
the preset configuration information is stored in a cloud server; and
determining corresponding preset configuration information according to the wireless device information includes:
sending the type information of the wireless device to the cloud server;
determining the corresponding preset configuration information by the cloud server according to the type information of the wireless device; and
receiving the preset configuration information from the cloud sever.

12. The gateway device of claim 11, the processor is further configured to:
acquire first verification information of the wireless device;
acquire second verification information sent by the cloud server; and
configure the corresponding wireless device according to the preset configuration information in response to the first verification information and the second verification information satisfying a preset condition.

13. The gateway device of claim 9, the processor is further configured to, after configuring the corresponding wireless device according to the preset configuration information:
send the type information of the wireless device and status information of the wireless device to the cloud server, the cloud server storing the type information of the wireless device and the status information of the wireless device associated with a preset user account.

14. The gateway device of claim 9, the processor is further configured to, after configuring the corresponding wireless device according to the preset configuration information:
send the type information of the wireless device and the status information of the wireless device to the client and forwarding the type information of the wireless device and the status information of the wireless device to the cloud server through the client, the cloud server storing the type information of the wireless device and the status information of the wireless device in association with the preset user account.

15. The gateway device of claim 9, wherein:
the gateway device supports multiple gateway protocols, and the wireless device has multiple functional modules; and
configuring the corresponding wireless device according to the preset configuration information includes:
binding each the functional module of the wireless device with a corresponding gateway protocol.
